(19) United States
(12) Patent Application Publication
(10) Pub. No.: US 2019/0181432 A1
(43) Pub. Date: Jun. 13, 2019

(54) CATHODE MIXTURE, CATHODE ACTIVE MATERIAL LAYER, ALL SOLID STATE BATTERY, AND METHOD FOR PRODUCING CATHODE ACTIVE MATERIAL LAYER

(71) Applicant: TOYOTA JIDOSHA KABUSHIKI KAISHA, Toyota-shi (JP)

(72) Inventors: Yuhki YUI, Susono-shi (JP); Daichi KOSAKA, Susono-shi (JP); Jun YOSHIDA, Sunto-gun (JP)

(21) Appl. No.: 16/205,910

(22) Filed: Nov. 30, 2018

(30) Foreign Application Priority Data
Dec. 12, 2017 (JP) 2017-237904

(51) Int. Cl. H01M 4/36; H01M 10/0585; H01M 10/0562; H01M 4/485

(52) U.S. Cl. CPC H01M 4/364; H01M 10/0585; H01M 2004/028; H01M 4/485; H01M 10/0562

(57) ABSTRACT

An object of the present disclosure is to provide a cathode mixture with high energy density per volume. The present disclosure achieves the object by providing a cathode mixture to be used in an all solid state battery, the cathode mixture comprising: a first cathode active material, a second cathode active material, and a sulfide solid electrolyte; and a ratio of an average particle diameter of the first cathode active material to an average particle diameter of the second cathode active material is 2.0 or more and 4.3 or less.

### TECHNICAL FIELD

The present disclosure relates to a cathode mixture with high energy density per volume.

### BACKGROUND ART

In accordance with the rapid spread of information relevant apparatus and communication devices such as a personal computer, a video camera, and a portable telephone in recent years, the development of a battery used for the power source thereof has been emphasized. The development of a high-output and high-capacity battery for an electric automobile or a hybrid automobile has been advanced also in the automobile industry. A lithium battery has been presently noticed from the viewpoint of high energy density among various kinds of batteries.

Organic liquid electrolyte (electrolyte solution) using a flammable organic solvent is used for a presently commercialized lithium battery, so that the installation of a safety device for restraining temperature rise during a short circuit and the structure for preventing the short circuit are necessary therefor. On the contrary, an all solid state battery replacing the liquid electrolyte with a solid electrolyte is conceived to intend the simplification of the safety device and be excellent in production cost and productivity for the reason that the flammable organic solvent is not used in the battery.

In these lithium batteries, various efforts have been made in a cathode mixture in order to improve the energy density per volume.

For example, Patent Literature 1 describes a cathode mixture for a lithium secondary battery using electrolyte solution, in which an active material particle with large average particle diameter and an active material particle with small average particle diameter are mixed.

Also, Patent Literature 2 describes a cathode mixture containing a cathode active material having two or more peaks on an amount of distribution in the particle size distribution.

In addition, Patent Literature 3 describes a cathode mixture for an all solid state battery in which an inorganic solid particle with small average particle diameter is slightly contained in addition to an active material particle with large average particle diameter and a solid electrolyte particle so as to improve flowability of constituent materials to inhibit generation of void in a cathode active material layer.

### CITATION LIST

### Patent Literatures

Patent Literature 1: Japanese Patent Application Publication (JP-A) No. 2009-146788
Patent Literature 2: JP-A No. 2009-76402
Patent Literature 3: JP-A No. 2016-81617

### SUMMARY OF DISCLOSURE

### Technical Problem

Improvement in the energy density per volume has been demanded for improving performance of an all solid state battery.

The present disclosure has been made in view of the above circumstances, and a main object thereof is to provide a cathode mixture with high energy density per volume.

### Solution to Problem

In order to achieve the object, the present disclosure provides a cathode mixture to be used in an all solid state battery, the cathode mixture comprising: a first cathode active material, a second cathode active material, and a sulfide solid electrolyte; and a ratio of an average particle diameter of the first cathode active material to an average particle diameter of the second cathode active material is 2.0 or more and 4.3 or less.

According to the present disclosure, the particle diameter ratio of the first cathode active material and the second cathode active material is specified and thus the energy density per volume may be improved.

In the disclosure, it is preferable that the average particle diameter of the first cathode active material is 6 μm or more and 13 μm or less. Thereby, the contact of the cathode active material with the other constituent materials effectively increases.

In the disclosure, it is preferable that the average particle diameter of the second cathode active material is 3 μm or less. Thereby, the contact of the cathode active material with the other constituent materials effectively increases.

In the disclosure, it is preferable that the first cathode active material and the second cathode active material are a metal oxide including at least one kind of a transitional metal selected from nickel (Ni), manganese (Mn), and cobalt (Co); and lithium (Li). Thereby, the contact of the cathode active material with the other constituent materials may be easily increased.

In the disclosure, it is preferable that the sulfide solid electrolyte contains an ion conductor including Li, P, and S; and LiBr. Thereby, the contact of the cathode active material with the other constituent materials effectively increases.

In the disclosure, it is preferable that the first cathode active material and the second cathode active material are a compound with same constituent element. The reason therefor is to allow stable drive of an all solid state battery using the cathode mixture.

Also, the present disclosure provides a cathode active material layer to be used in an all solid state battery, the cathode active material layer comprising: a first cathode active material, a second cathode active material, and a sulfide solid electrolyte; and a ratio of an average particle diameter of the first cathode active material to an average particle diameter of the second cathode active material is 2.0 or more and 4.3 or less.

According to the present disclosure, the particle diameter ratio of the first cathode active material and the second cathode active material is specified and thus the energy density per volume may be improved.

Also, the present disclosure provides an all solid state battery comprising: a cathode active material layer, an anode active material layer, and a solid electrolyte layer formed between the cathode active material layer and the anode active material layer; wherein, the cathode active material layer contains a first cathode active material, a second cathode active material, and a sulfide solid electrolyte; and a ratio of an average particle diameter of the first cathode active material to an average particle diameter of the second cathode active material is 2.0 or more and 4.3 or less.

According to the present disclosure, the cathode active material layer contains the first cathode active material and the second cathode active material having the specific particle diameter ratio, and thus the energy density per volume may be improved.

Also, the present disclosure provides a method for producing a cathode active material layer to be used in an all solid state battery, the method comprising: a cathode mixture layer forming step of forming a cathode mixture layer using a cathode mixture comprising a first cathode active material, a second cathode active material, and a sulfide solid electrolyte, and a ratio of an average particle diameter of the first cathode active material to an average particle diameter of the second cathode active material is 2.0 or more and 4.3 or less; and a roll press step of performing roll press to the cathode mixture layer.

According to the present disclosure, the particle diameter ratio of the first cathode active material and the second cathode active material is in the specific range, and thus a cathode active material layer with high energy density per volume may be obtained.

In the disclosure, it is preferable that the average particle diameter of the first cathode active material is 8 μm or more and 12 μm or less; the average particle diameter of the second cathode active material is 3 μm or less; a proportion of the second cathode active material to a total of the first cathode active material and the second cathode active material is 10 volume % or more and 30 volume % or less; and in the roll press step, roll press is performed with a linear pressure of 20 kN/cm or more and 30 kN/cm or less.

### Advantageous Effects of Disclosure

According to the present disclosure, a cathode mixture with high energy density per volume can be provided.

### BRIEF DESCRIPTION OF DRAWING

FIG. 1 is a schematic cross-sectional view illustrating an example of the all solid state battery of the present disclosure.

FIGS. 2A to 2E are schematic cross-sectional views illustrating an example of the method for producing the all solid state battery of the present disclosure.

FIGS. 3A to 3C are schematic cross-sectional views illustrating an example of the method for producing the cathode active material layer of the present disclosure.

FIG. 4 is a graph showing the result of linear pressure and filling rate.

### DESCRIPTION OF EMBODIMENTS

The cathode mixture, the all solid state battery, and the method for producing the cathode active material layer of the present disclosure are hereinafter described in details.

A. Cathode Mixture

The cathode mixture of the present disclosure is a cathode mixture to be used in an all solid state battery, the cathode mixture comprising: a first cathode active material, a second cathode active material, and a sulfide solid electrolyte; and a ratio of an average particle diameter of the first cathode active material to an average particle diameter of the second cathode active material is 2.0 or more and 4.3 or less.

In the present disclosure, the average particle diameter refers to D₅₀ in particle distribution. Incidentally, the particle distribution is an index that shows how large (particle diameter) particles are included in how many proportions (relative distribution amount when the whole is regarded as 100%). In a commercialized material, just one peak of the distribution amount is usually present. Also, in the particle distribution of a particle of which particle diameter is adjusted by crushing thereof by, for example, ball milling, just one peak of the distribution amount is present in accordance with the regular distribution in general.

According to the present disclosure, the particle diameter ratio of the first cathode active material and the second cathode active material is specified and thus the energy density per volume may be improved. In addition, an all solid state battery with high energy density per volume can be produced even if the pressing linear pressure at the time of forming a cathode active material layer by pressing is low. Thus, the all solid state battery with high energy density per volume can be produced with high productivity. The reason why such an effect can be obtained is presumed as follows.

When the cathode active material layer is formed by pressing using the cathode mixture, the first cathode active materials are mostly not plastically deformed so as not to cohere to each other to generate voids between particles of the first cathode active material, and thus the second cathode active material with smaller average particle diameter can be presumably easily go into the void. As the result, the contact of the cathode active material with the other constituent materials increases to presumably increase a Li ion conducting path and an electron conducting path. Thereby, it is presumed that the energy density per volume is improved. Also, the second cathode active material with small average particle diameter is mixed with the cathode mixture so as to increase the contact of the cathode active material with the sulfide solid electrolyte to increase the Li ion conducting path, and thus the energy density per volume is presumably improved. Further, when the ratio of the average particle diameters is in the specific range, on the occasion of forming the cathode active material layer by pressing, it is presumed that the pressing linear pressure can be reduced in order for the second cathode active material with small average particle diameter to easily go into an appropriate position in the void generated between particles of the first cathode active material. From the above reasons, the effect is presumably obtained.

The cathode mixture of the present disclosure is hereinafter described in each constitution.

1. First Cathode Active Material and Second Cathode Active Material

(1) Ratio of Average Particle Diameter of First Cathode Active Material to Average Particle Diameter of Second Cathode Active Material

The ratio of the average particle diameter of the first cathode active material to the average particle diameter of the second cathode active material is 2.0 or more and 4.3 or less. If the ratio of the average particle diameters is smaller than the specific range, the void between particles of the first cathode active material becomes small and thus the second cathode active material cannot easily go into the void between particles of the first cathode active material, and the contact of the cathode active material with the other constituent materials cannot easily increase. Also, if the ratio is larger than the specific range, aggregation of the second cathode active material easily occurs and there is a risk that the contact of the cathode active material with the other constituent materials may not increase. For the same reasons, the ratio of the average particle diameters is preferably 2.7 or more and 4.0 or less, above all.

(2) First Cathode Active Material

There are no particular limitations on the kind of the first cathode active material, and examples thereof may include an oxide active material and a sulfide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, and LiNi_{0.5}Mn_{1.5}O₄; an olivine type active material such as LiFePO₄ and LiMnPO₄; and a Si-containing active material such as Li₂FeSiO₄ and Li₂MnSiO₄. Also, examples of the oxide active material other than above may include Li₄Ti₅O₁₂.

The kind of the first cathode active material is preferably a metal oxide including at least one kind of transition metal selected from nickel (Ni), manganese (Mn), and cobalt (Co); and lithium (Li). The reason therefor is that it is not easily plastically deformed and thus the void between particles of the first cathode active material is easily generated to facilitate increase of the contact of the cathode active material with the other constituent materials. Examples of the kind of such a metal oxide may include a lithium nickelate (LiNiO₂), a lithium manganate (LiMn₂O₄), a lithium cobaltate (LiₓCoO₂), lithium nickel cobalt manganate (Li₁₊ₓNi_{1/3}Co_{1/3}Mn_{1/3}O₂), and a combination of these.

Examples of the shape of the first cathode active material may include a granular shape. The average particle diameter (D₅₀) of the first cathode active material is, for example, 0.1 μm or more, may be 6 μm or more, and may be 8 μm or more. Meanwhile, the average particle diameter (D₅₀) of the first cathode active material is, for example, 50 μm or less, may be 13 μm or less, and may be 12 μm or less. If the average particle diameter is too small, the void between the particles of the first cathode active material becomes small, and thus the second cathode active material cannot easily go into the void between the particles of the first cathode active material, and the contact of the cathode active material with the other constituent materials cannot easily increase. If the average particle diameter is too large, there is a risk that the contact of the cathode active material with the other constituent materials may not increase.

Also, there are no particular limitations on the first cathode active material; however, the one with the particle distribution in accordance with the regular distribution is preferable. The average particle diameter (D₅₀) of the first cathode active material becomes D₅₀ in the particle distribution in accordance with the regular distribution; thus, the operation the contact of the cathode active material with the other constituent materials increases to increase Li ion conducting path and electron conducting path can be effectively obtained thereby.

The first cathode active material may be the one whose surface is coated with a coating layer. The coating layer may inhibit the reaction of the first cathode active material with the sulfide solid electrolyte. Examples of the coating layer may include a Li ion conductive oxide such as LiNbO₃, Li₃PO₄, and LiPON. The average thickness of the coating layer is 1 nm or more for example. Meanwhile, the average thickness of the coating layer is, for example, 20 nm or less, and may be 10 nm or less.

(3) Second Cathode Active Material

The kind of the second cathode active material is the same as the kind of the first cathode active material; thus the explanation herein is omitted. Also, the first cathode active material and the second cathode active material may be a compound with the same constituent elements, and may be compounds with different constituent elements from each other; however, the former is preferable. In particular, the first cathode active material and the second cathode active material are preferably a compound with the same constituent elements and composition.

Examples of the shape of the second cathode active material may include a granular shape. The average particle diameter (D₅₀) of the second cathode active material is, for example, 0.1 μm or more, may be 0.2 μm or more, and may be 0.5 μm or more. Meanwhile, the average particle diameter (D₅₀) of the second cathode active material is, for example, 10 μm or less, and may be 3 μm or less. If the average particle diameter is too small, the aggregation of the second cathode active material easily occurs and there is a risk that the contact of the cathode active material with the other constituent materials may not increase. If the average particle diameter is too large, the void between the particles of the cathode active material becomes large and thus there is a risk that the contact of the cathode active material with the other constituent materials may not increase.

Also, there are no particular limitations on the second cathode active material; however, the one with the particle distribution in accordance with the regular distribution is preferable. The average particle diameter (D₅₀) of the second cathode active material becomes D₅₀ in the particle distribution in accordance with the regular distribution; thus, the operation the contact of the cathode active material with the other constituent materials increases to increase Li ion conducting path and electron conducting path can be effectively obtained thereby.

Also, the second cathode active material may be the one whose surface is coated with a coating layer. The coating layer may inhibit the reaction of the second cathode active material with the sulfide solid electrolyte. The coating layer is in the same contents as those described in “(2) First cathode active material” above.

There are no particular limitations on the volume ratio of the first cathode active material and the second cathode active material; for example, when the average particle diameter (D₅₀) of the first cathode active material is 8 μm or more and 12 μm or less, and the average particle diameter (D₅₀) of the second cathode active material is 1 μm or more and 3 μm or less, it is preferably in the range of the first cathode active material:the second cathode active material=90:10 to 70:30. The volume ratio in such a range facilitates the second cathode active material going into the void between the particles of the first cathode active material, and thus the contact of the cathode active material with the other constituent materials can easily increase. Also, when the average particle diameter (D₅₀) of the first cathode active material is 6 μm or more and 15 μm or less, and the average particle diameter (D₅₀) of the second cathode active material is 1 μm or more and 3 μm or less, the range is preferably the first cathode active material:the second cathode active material=80:20 to 60:40 for the same reasons.

2. Sulfide Solid Electrolyte

The sulfide solid electrolyte usually mainly includes a sulfur element as an anion element. Examples of the sulfide solid electrolyte may include Li₂S—P₂S₅, Li₂S—P₂S₅—LiI, Li₂S—P₂S₅—LiCl, Li₂S—P₂S₅—LiBr, Li₂S—P₂S₅—LiBr—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are a real number; Z is either one of Ge, Zn, and Ga), Li₂S—GeS₂, Li₂S—SiS₂—Li₃PO₄, Li₂S—SiS₂-LiₓMO_{y} (provided that x and y are a real number; M is either one of P, Si, Ge, B, Al, Ga, and In), and Li₁₀GeP₂S₁₂. Also, the sulfide solid electrolyte may be amorphous, may be crystalline, and may be glass ceramic.

The sulfide solid electrolyte preferably contains an ion conductor including Li, P, and S; and LiBr. They are soft and easily plastically deformed, and thus the sulfide solid electrolyte can be easily placed between the particles of the active material to effectively increase the contact of the cathode active material with the other constituent materials.

At least a part of the LiBr is usually present in the state taken into the structure of the ion conductor as a LiBr component. Also, the sulfide solid electrolyte may or may not have a peak in an X-ray diffraction measurement, but the latter is preferable. The reason therefor is that the ion conductivity thereof is high.

The ion conductor includes Li, P, and S. There are no particular limitations on the ion conductor if it includes Li, P, and S; however, above all, an ortho composition is preferably included. The reason therefor is to allow the sulfide solid electrolyte to have high chemical stability. Here, the ortho means generally the one among oxoacids obtained by hydrating the same oxide of which degree of hydration is the highest. In the present disclosure, a crystal composition with the most Li₂S among sulfides is referred to as the ortho composition. For example, in Li₂S—P₂S₅ series, Li₃PS₄ falls under the ortho composition.

Also, in the present disclosure, “including an ortho composition” means not only the ortho composition in a strict sense, but it also includes the compositions close thereto. In specific, it means that an anion structure of the ortho composition (PS₄³⁻ structure) is mainly included. The proportion of the anion structure of the ortho composition to overall anion structures in the ion conductor is, preferably 60 mol or more, more preferably 70 mol % or more, further preferably 80 mol % or more, and particularly preferably 90 mol % or more. Incidentally, the proportion of the anion structure of the ortho composition may be determined by a method such as Raman spectroscopy, NMR, and XPS.

Also, the sulfide solid electrolyte may or may not contain Li₂S, but the latter is preferable. The sulfide solid electrolyte not containing Li₂S may have high chemical stability. The state “not containing Li₂S” can be confirmed by an X-ray diffraction. In specific, if there is no peak of Li₂S (2θ=27.0°, 31.2°, 44.8°, and 53.1°), the state can be judged as not containing Li₂S.

Also, the sulfide solid electrolyte may or may not contain a cross-linking sulfur, but the latter is preferable. The sulfide solid electrolyte not containing the cross-linking sulfur may have high chemical stability. “Cross-linking sulfur” refers to a cross-linking sulfur in the composition configured by the reaction of Li₂S with P₂S₅. For example, the cross-linking sulfur of S₃P—S—PS₃ structure configured by the reaction of Li₂S with P₂S₅ corresponds thereto. The state “not containing a cross-linking sulfur” can be confirmed by Raman spectroscopy measurement. For example, in the case of a sulfide solid electrolyte in Li₂S—P₂S₅ series, the peak of the S₃P—S—PS₃ structure usually appears at 402 cm⁻¹. Accordingly, it is preferable that this peak is not detected.

Also, in the case of a sulfide solid electrolyte in Li₂S—P₂S₅ series, the ratio of Li₂S and P₂S₅ to obtain the ortho composition is Li₂S:P₂S₅=75:25 in mole basis. The proportion of Li₂S to the total of Li₂S and P₂S₅ is preferably in a range of 70 mol % to 80 mol %, more preferably in a range of 72 mol % to 78 mol %, and further preferably in a range of 74 mol % to 76 mol %.

Also, there are no particular limitations on the proportion of LiBr in the sulfide solid electrolyte if the proportion allows the desired sulfide solid electrolyte to be obtained; for example, the proportion is preferably in a range of 10 mol % to 30 mol %, and more preferably in a range of 15 mol % to 25 mol %. Incidentally, when the sulfide solid electrolyte has the composition of aLiBr.(1-a) (bLi₂S.(1-b)P₂S₅), “a” corresponds to the proportion of the LiBr, and “b” corresponds to the proportion of the Li₂S.

Examples of the shape of the sulfide solid electrolyte may include a granular shape. The average particle diameter (D₅₀) of the sulfide solid electrolyte in a granular shape is preferably in a range of 0.1 μm to 50 μm, for example. Also, the Li ion conductivity of the sulfide solid electrolyte is preferably high; the Li ion conductivity at a normal temperature is, for example, preferably 1×10⁻⁴ S/cm or more, and more preferably 1×10⁻³ S/cm or more.

The sulfide solid electrolyte may be, for example, sulfide glass and may be glass ceramic. The sulfide solid electrolyte may, for example, include at least one of Li₂S, P₂S₅, and LiBr that are raw materials.

3. Cathode Mixture

The cathode mixture of the present disclosure comprises at least the first cathode active material, the second cathode active material, and the sulfide solid electrolyte. The cathode mixture may further contain a conductive material. The electron conductivity of the cathode mixture can be improved by adding the conductive material. Examples of the conductive material may include a carbon material such as acetylene black (AB), Ketjen black (KB), vapor grown carbon fiber (VGCF), carbon nanotube (CNT), and carbon nanofiber (CNF).

The cathode mixture may further contain a binder. The formability of the cathode mixture can be improved by adding the binder. Examples of the binder may include polyvinylidene fluoride (PVDF), butylene rubber (BR), and styrene butadiene rubber (SBR). The cathode mixture may further contain a thickener.

There are no particular limitations on the shape of the cathode mixture, and examples thereof may include a powder shape and a pellet shape.

B. All Solid State Battery

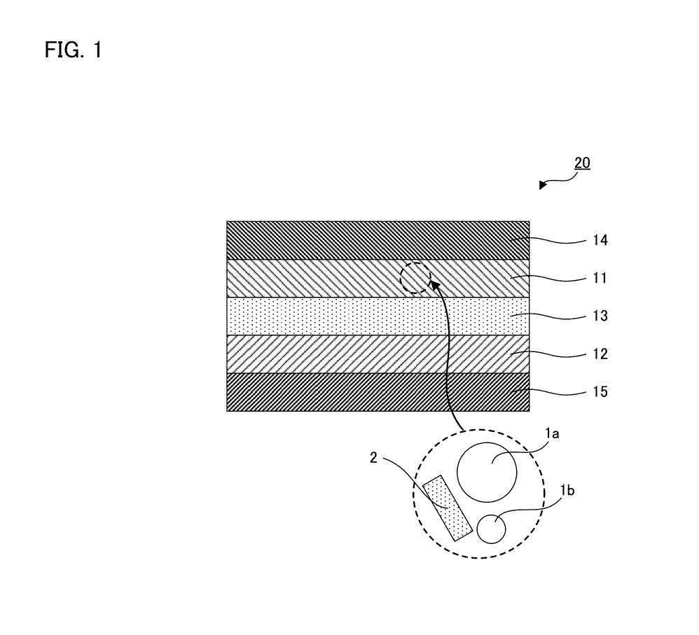

FIG. 1 is a schematic cross-sectional view illustrating an example of the all solid state battery of the present disclosure. All solid state battery 20 in FIG. 1 has cathode active material layer 11 containing a cathode active material, anode active material layer 12 containing an anode active material, solid electrolyte layer 13 formed between cathode active material layer 11 and anode active material layer 12, cathode current collector 14 for collecting currents of cathode active material layer 11, and anode current collector 15 for collecting currents of anode active material layer 12. The present disclosure features the configuration that cathode active material layer 11 contains first cathode active material 1a, second cathode active material 1b, and sulfide solid electrolyte 2, and the ratio of the average particle diameter of first cathode active material 1a to the average particle diameter of second cathode active material 1b is 2.0 or more and 4.3 or less.

According to the present disclosure, the cathode active material layer contains the first cathode active material and the second cathode active material in the specific particle diameter ratio so as to allow the energy density per volume to improve.

The all solid state battery of the present disclosure is hereinafter explained in each constitution.

1. Cathode Active Material Layer

The cathode active material layer in the present disclosure contains at least a first cathode active material, a second cathode active material, and a sulfide solid electrolyte, and the ratio of the average particle diameter of the first cathode active material to the average particle diameter of the second cathode active material is 2.0 or more and 4.3 or less.

The materials for the cathode active material layer including the first cathode active material, the second cathode active material, and the sulfide solid electrolyte are the same materials for the cathode mixture described in “A. Cathode mixture” above; thus, the explanation herein is omitted.

The filling rate of the cathode active material layer is, for example, 85% or more, may be 90% or more, and may be 93′ or more. The measurement method of the filling rate is described later in Examples.

The thickness of the cathode active material layer is, for example, in a range of 0.1 μm to 1000 μm, and preferably in a range of 0.1 μm to 300 μm.

Incidentally, the present disclosure can also provide a cathode active material layer comprising a first cathode active material, a second cathode active material, and a sulfide solid electrolyte; and a ratio of the average particle diameter of the first cathode active material to the average particle diameter of the second cathode active material is 2.0 or more ad 4.3 or less.

2. Anode Active Material Layer

The anode active material layer in the present disclosure is a layer containing at least an anode active material, and may further contain at least one of a sulfide solid electrolyte, a conductive material, and a binder as required. The sulfide solid electrolyte, the conductive material, and the binder are in the same contents as those described in “A. Cathode mixture” above; thus, the explanation herein is omitted.

Examples of the anode active material may include a carbon active material, a metal active material, and an oxide active material. Examples of the carbon active material may include graphite, hard carbon, and soft carbon. Examples of the metal active material may include In, Al, Si, Sn, and an alloy including at least these. Examples of the oxide active material may include Nb₂O, Li₄Ti₅O₁₂, and SiO. The thickness of the anode active material layer is, for example, in a range of 0.1 μm to 1000 μm, and preferably in a range of 0.1 μm to 300 μm.

3. Solid Electrolyte Layer

The solid electrolyte layer in the present disclosure is a layer formed between the cathode active material layer and the anode active material layer. The solid electrolyte layer is a layer containing at least a solid electrolyte, and may further contain a binder as required. The solid electrolyte layer preferably contains a sulfide solid electrolyte. The sulfide solid electrolyte and the binder are in the same contents as those described in “A. Cathode mixture” above.

The proportion of the solid electrolyte included in the solid electrolyte layer is, for example, in a range of 10 volume % to 100 volume %, and preferably in a range of 50 volume % to 100 volume %. The thickness of the solid electrolyte layer is, for example, in a range of 0.1 μm to 1000 μm, and preferably in a range of 0.1 μm to 300 μm. Also, examples of the method for forming the solid electrolyte layer may include a method in which a solid electrolyte is compression-molded.

4. Other Constitutions

The all solid state battery of the present disclosure comprises at least the abode described cathode active material layer, anode active material layer, and solid electrolyte layer, and usually further comprises a cathode current collector for collecting currents of the cathode active material layer, and an anode current collector for collecting currents of the anode active material layer. Examples of the materials for the cathode current collector may include SUS, Ni, Cr, Au, Pt, Al, Fe, Ti, and Zn. Meanwhile, examples of the materials for the anode current collector may include SUS, Cu, Ni, Fe, Ti, Co, and Zn. Also, in the present disclosure, an arbitrary battery case such as a battery case made of SUS can be used for example.

5. All Solid State Battery

The all solid state battery of the present disclosure may be a primary battery and may be a secondary battery, but preferably a secondary battery among them, so as to be repeatedly charged and discharged, and useful as a car-mounted battery, for example. Examples of the shape of the all solid state battery may include a coin shape, a laminate shape, a cylindrical shape, and a square shape.

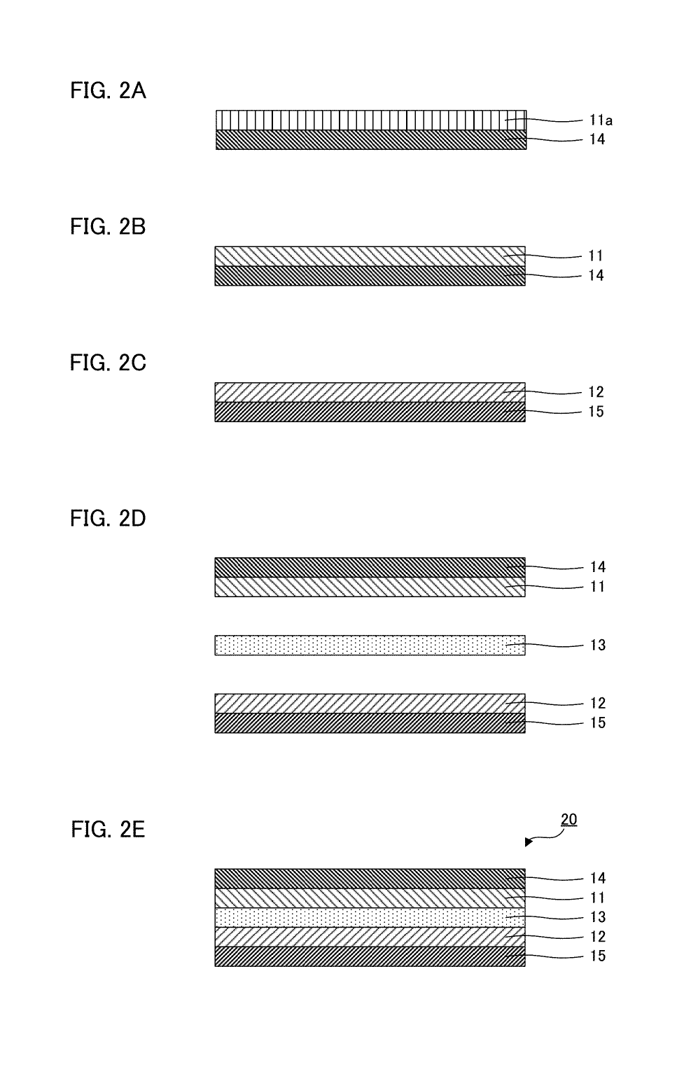

FIGS. 2A to 2E are schematic cross-sectional views illustrating an example of the method for producing the all solid state battery. In FIGS. 2A to 2E, first, a layered body including cathode current collector 14, and cathode mixture layer 11a used as to be the cathode active material layer, in this order, is prepared (FIG. 2A). Next, the roll press step is performed to this layered body to obtain a cathode layered body including cathode current collector 14 and cathode active material layer 11 in this order (FIG. 2B). Next, by an arbitrary method, an anode layered body including anode current collector 15 and anode active material layer 12 in this order is prepared (FIG. 2C). Next, cathode active material layer 11 of the cathode layered body is arranged on one surface side of solid electrolyte layer 13, and anode active material layer 12 of the anode layered body is arranged on the other surface side (FIG. 2D). By pressing the layered body in the thickness direction, all solid state batter 20 including cathode active material layer 11, anode active material layer 12, solid electrolyte layer 13 formed between cathode active material layer 11 and anode active material layer 12, cathode current collector 14 collecting currents of cathode active material layer 11, and anode current collector 15 collecting currents of anode active material layer 12, is obtained (FIG. 2E).

C. Method for Producing Cathode Active Material Layer

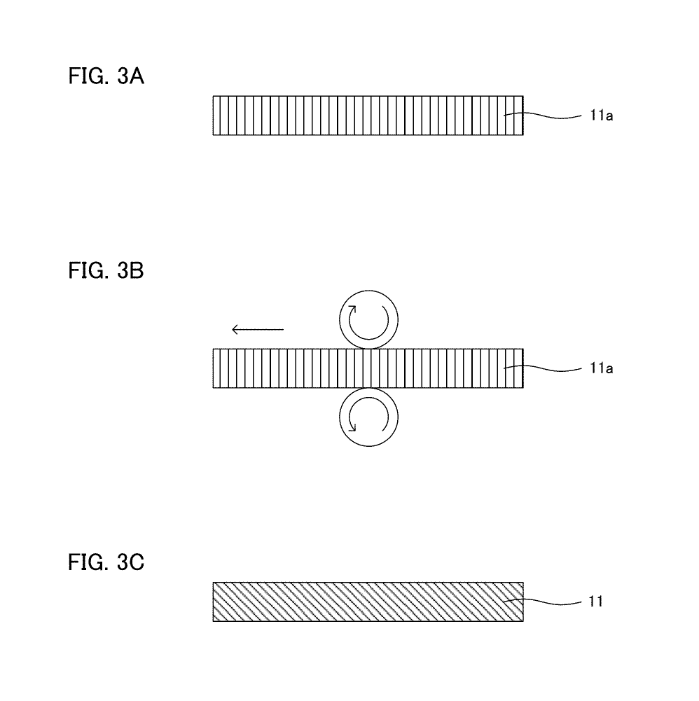

FIGS. 3A to 3C are schematic cross-sectional views illustrating an example of the method for producing the cathode active material layer of the present disclosure. In FIGS. 3A to 3C, first, cathode mixture layer 11a is formed by using a cathode mixture comprising a first cathode active material, a second cathode active material, and a sulfide solid electrolyte, and a ratio of an average particle diameter of the first cathode active material to an average particle diameter of the second cathode active material is 2.0 or more and 4.3 or less (FIG. 3A; cathode mixture layer forming step). Next, cathode mixture layer 11a is roll pressed (FIG. 3B; roll press step). Thereby, cathode active material layer 11 is obtained (FIG. 3C).

According to the present disclosure, the particle diameter ratio of the first cathode active material and the second cathode active material is in the specific range and thus a cathode active material layer with high energy density per volume may be obtained.

The method for producing the cathode active material layer of the present disclosure is hereinafter explained in each step.

1. Cathode Mixture Layer Forming Step

The cathode mixture forming step in the present disclosure is a step of forming a cathode mixture layer using a cathode mixture comprising a first cathode active material layer, a second cathode active material layer, and a sulfide solid electrolyte, and a ratio of an average particle diameter of the first cathode active material to an average particle diameter of the second cathode active material is 2.0 or more and 4.3 or less.

The cathode mixture is in the same contents as those described in “A. Cathode mixture” above; thus, the descriptions herein are omitted. In particular, in the present disclosure, it is preferable that the average particle diameter (D₅₀) of the first cathode active material is 8 μm or more and 12 μm or less, the average particle diameter (D₅₀) of the second cathode active material is 1 μm or more and 3 μm or less, and the first cathode active material:the second cathode active material=90:10 to 70:30 (in volume ratio).

Examples of the method for forming the cathode mixture layer may include a slurry method. In the slurry method, the cathode mixture layer is obtained by pasting cathode mixture slurry on a substrate and drying thereof. The cathode slurry may be obtained by, for example, adding a dispersion medium to the cathode mixture and kneading thereof. Examples of the mean for kneading may include an ultrasonic homogenizer, a shaker, a thin film orbiting type mixer, a dissolver, a homo-mixer, a kneader, a roll mill, a sand mill, an attritor, a ball mill, a vibrator mill, and a high-speed impeller mill. Examples of the method for pasting may include a doctor blade method, a die coat method, a gravure coat method, a spray coat method, a static coat method, and a bar coat method.

There are no particular limitations on the substrate on which the cathode mixture slurry is pasted, for example, if the material allows the cathode mixture layer to be maintained; however, the material is preferably a cathode current collector. The reason therefor is to simplify the steps of producing the all solid state battery. The material for the cathode current collector is typically a metal. Examples of the material suitable for the cathode current collector may include SUS, aluminum, nickel, iron, titanium, and carbon.

2. Roll Press Step

The roll press step in the present disclosure is a step of performing roll press to the cathode mixture layer.

The linear pressure to be applied at the time of the roll press is, for example, 15 kN/cm or more, and may be 20 kN/cm or more. The linear pressure is, for example, 50 kN/cm or less, may be 40 kN/cm or less, and may be 30 kN/cm or less.

In particular, when the average particle diameter of the first cathode active material is 8 μm or more and 12 μm or less, the average particle diameter of the second cathode active material is 3 μm or less, and the proportion of the second cathode active material to the total of the first cathode active material and the second cathode active material is 10 volume % or more and 30 volume % or less, the linear pressure to be applied at the time of the roll press is preferably 20 kN/cm or more and 30 kN/cm or less.

In the roll press step, heating may be performed at the same time of the roll press. In that case, it is preferable that the heating temperature is a temperature of the crystallization temperature of the sulfide solid electrolyte or more.

3. Cathode Active Material Layer

The cathode active material layer to be obtained by the production method of the present disclosure is in the same contents as those described in “B. All solid state battery 1. Cathode active material layer” above; thus, the descriptions herein are omitted.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation thereto.

### EXAMPLES

The present disclosure is hereinafter explained in more details with reference to Examples.

### Example 1

Preparation of Cathode Active Material

As the first cathode active material, lithium nickel cobalt manganate (Li₁₊ₓNi_{1/3}Co_{1/3}Mn_{1/3}O₂) (average particle diameter (D₅₀)=13 μm) was prepared. As the second cathode active material, lithium nickel cobalt manganate (Li₁₊ₓNi_{1/3}Co_{1/3}Mn_{1/3}O₂) (average particle diameter (D₅₀)=3 μm) was prepared.

Preparation of Anode Active Material

As the anode active material, graphite (from Mitsubishi Chemical Corporation; average particle diameter (D₅₀)=10 μm) was prepared.

Preparation of Sulfide Solid Electrolyte

Li₂S (from Nippon Chemical Industrial Co., Ltd.), P₂S₅ (from Sigma-Aldrich Co. LLC.), and LiBr (from NIPPOH CHEMICALS CO., LTD.) were used as starting raw materials. Each material was mixed for 5 minutes with an agate mortar so as to be 20LiBr.80(0.75Li₂S.0.25P₂S₅) in the molar ratio. The mixture of 2 g was projected into a container (45 cc, made of ZrO₂) for a planetary ball mill, dehydrated heptane (water content of 30 ppm or less, 4 g) was projected thereinto, and a ZrO₂ ball (ϕ=5 mm, 53 g) was further projected thereinto to completely seal the container. This container was installed to a planetary ball mill machine (P7 from Fritsch Japan Co., Ltd), and mechanical milling was performed for 2 hours at the weighting table rotation number of 500 rpm. After that, the heptane was removed by drying thereof at 110° C. for 1 hour to obtain a sulfide solid electrolyte (sulfide glass).

Fabrication of Cathode Mixture Slurry

A coating layer (average thickness: 10 nm) that was LiNbO₃ was formed on the surface of the first cathode active material and the second cathode active material using a tumbling fluidized bed granulating-coating machine (MP01 from Powrex Corporation).

Then, the first cathode active material, the second cathode active material, the sulfide solid electrolyte, a binder (PVDF), and a conductive material (VGCF) were mixed in the weight ratio of the first cathode active material:the second cathode active material:the sulfide solid electrolyte:the binder:the conductive material=80:20:12:1.5:1.5. Incidentally, the volume ratio of the first cathode active material and the second cathode active material was 80:20. After that, the obtained mixture and a dispersion medium (butyl acetate) were put into a container and kneaded using an ultrasonic homogenizer to obtain a cathode mixture slurry.

Fabrication of Anode Mixture Slurry

The anode active material, the sulfide solid electrolyte, a binder (PVDF), and a conductive material (VGCF) were mixed in the weight ratio of the anode active material:the sulfide solid electrolyte:the binder:the conductive material=100:77.6:2:8. After that, the obtained mixture and a dispersion medium (butyl acetate) were put into a container and kneaded using an ultrasonic homogenizer to obtain an anode mixture slurry.

Fabrication of Cathode Active Material Layer

The cathode slurry was pasted on an Al foil used as the cathode current collector by a blade method using an applicator. This was dried on a hot plate at 100° C. for 30 minutes to form a cathode active material layer (mixture layer) on the cathode current collector.

Fabrication of Anode Active Material Layer

The anode slurry was pasted on a Cu foil used as the anode current collector by a blade method using an applicator. This was dried on a hot plate at 100° C. for 30 minutes to form an anode active material layer on the anode current collector.

Fabrication of Solid Electrolyte Layer

An electrolyte mixture containing the sulfide solid electrolyte, a dispersion medium (heptane), and a binder (heptane solution of a BR-based binder, 5 mass %) was put into a container made of polypropylene (PP). This was stirred by an ultrasonic dispersion apparatus (UH-50 from SMT Corporation) for 30 seconds, and shaken by a shaker (TTM-1 from SIBATA SCIENTIFIC TECHNOLOGY LTD.) for 30 minutes to prepare a solid electrolyte slurry.

The solid electrolyte slurry was pasted on an Al foil used as a peeling sheet by a blade method using an applicator. This was dried on a hot plate at 100° C. for 30 minutes to obtain a transfer sheet including the peeling sheet and a solid electrolyte layer.

Fabrication of Cathode Layered Body

A layered body in which the cathode current collector and the cathode active material layer (mixture layer) were layered in this order was set to a roll press machine, pressed with the pressing linear pressure of 25 kN/cm and at the pressing temperature of 160° C. (feeding speed of 0.5 m/min.) as the first pressing step to obtain a cathode layered body. Incidentally, the feeding speed of 0.5 m/min. corresponds to a speed of movement in approximately 1 cm per a second; the time (heating and pressurizing time) the mixture layer contacted the roll was extremely shorter than that of planar pressing. Also, the pressing temperature is a temperature of the roll surface measured by a non-contact type thermometer.

Fabrication of Anode Layered Body

A layered body in which the anode current collector and the anode active material layer were layered in this order was set to a roll pressing machine, and pressed with the pressing linear pressure of 20 kN/cm and at the pressing temperature of 25° C. as a second pressing step to obtain an anode layered body.

Incidentally, the anode layered body and the cathode layered body were fabricated so that the area of the anode layered body became larger than the area of the cathode layered body. The area ratio of the cathode layered body and the anode layered body was 1.00:1.08.

Fabrication of all Solid State Battery

The cathode layered body and the anode layered body including the solid electrolyte layer were layered so that the cathode active material layer of the cathode layered body faced to the solid electrolyte layer. This layered body was set to a planar uniaxial pressing machine and pressed for 1 minute with the pressing linear pressure of 200 MPa and at the pressing temperature of 120° C. as a third pressing step. Thereby, an all solid state battery was obtained.

### Example 2

An all solid state battery was obtained in the same manner as in Example 1 except that the average particle diameter (D₅₀) of the first cathode active material was changed to 12 μm.

### Example 3

An all solid state battery was obtained in the same manner as in Example 1 except that the average particle diameter (D₅₀) of the first cathode active material was changed to 10 μm, and the first cathode active material and the second cathode active material were mixed in the volume ratio of the first cathode active material:the second cathode active material=90:10.

### Example 4

An all solid state battery was obtained in the same manner as in Example 3 except that the first cathode active material and the second cathode active material were mixed in the volume ratio of the first cathode active material:the second cathode active material=80:20.

### Example 5

An all solid state battery was obtained in the same manner as in Example 3 except that the first cathode active material and the second cathode active material were mixed in the volume ratio of the first cathode active material the second cathode active material=70:30.

### Example 6

An all solid state battery was obtained in the same manner as in Example 3 except that the first cathode active material and the second cathode active material were mixed in the volume ratio of the first cathode active material the second cathode active material=60:40.

### Example 7

An all solid state battery was obtained in the same manner as in Example 3 except that the first cathode active material and the second cathode active material were mixed in the volume ratio of the first cathode active material:the second cathode active material=40:60.

### Example 8

An all solid state battery was obtained in the same manner as in Example 1 except that the average particle diameter (D₅₀) of the first cathode active material was changed to 8 μm.

### Example 9

An all solid state battery was obtained in the same manner as in Example 1 except that the average particle diameter (D₅₀) of the first cathode active material was changed to 6 μm.

### Example 10

An all solid state battery was obtained in the same manner as in Example 9 except that the first cathode active material and the second cathode active material were mixed in the volume ratio of the first cathode active material the second cathode active material=60:40, and in the first pressing step to obtain the cathode layered body, pressing was at the pressing linear pressure of 50 kN/cm.

### Example 11

An all solid state battery was obtained in the same manner as in Example 10 except that the first cathode active material and the second cathode active material were mixed in the volume ratio of the first cathode active material:the second cathode active material=40:60.

### Example 12

An all solid state battery was obtained in the same manner as in Example 10 except that the first cathode active material and the second cathode active material were mixed in the volume ratio of the first cathode active material:the second cathode active material=20:80.

### Comparative Example 1

An all solid state battery was obtained in the same manner as in Example 1 except that the average particle diameter (D₅₀) of the first cathode active material was changed to 6 μm, and in the first pressing step to obtain the cathode layered body, pressing was at the pressing linear pressure of 50 kN/cm.

### Comparative Example 2

An all solid state battery was obtained in the same manner as in Comparative Example 1 except that the first cathode active material and the second cathode active material were mixed in the volume ratio of the first cathode active material:the second cathode active material=60:40.

[Evaluation]

Filling Rate Measurement

The filling rate of the cathode active material layer fabricated in Examples 1 to 12 and Comparative Examples 1 to 2 was respectively measured. First, the apparent density of the cathode active material layer was calculated from the area, the thickness, and the mass of the cathode active material layer (the apparent density of the cathode active material layer=mass/(thickness*area). Next, the true density of the cathode active material layer was calculated from the true density and the content of the constituent components of the cathode active material layer (the true density of the cathode active material layer=mass/Σ (the content of each constituent component/the true density of each constituent component). The rate [%] of the apparent density to the true density was determined as the filling rate. The results are shown in Table 1.

Charge and Discharge Measurement

A charge and discharge measurement was conducted using the all solid state batteries obtained in Examples 1 to 12 as well as Comparative Examples 1 and 2. First, for conditioning, the battery was charged to 4.55 V by CCCV charging at the rate of 0.1 C, and then discharged to 3.0 V by CCCV discharging at the rate of 1 C. In the charge and discharge thereafter, the battery was charged and discharged by CCC charging and discharging at the rate of ⅓ C (the discharge specific capacity in Table 1 is the value in this condition). The voltage range was 3.0 to 4.35 V, and the measurement temperature was 25° C. The discharge specific capacity (mAh/cm³) was calculated by dividing the obtained discharge capacity by the volume of the cathode active material layer. The results are shown in Table 1.

TABLE 1

| | 1st cathode active | 2nd cathode active | Average | Cathode active material | Pressing | Discharge | |
|---|---|---|---|---|---|---|---|
| | material average | material average | particle | volume ratio | linear | specific | Filling |
| | particle diameter (A) | particle diameter (B) | diameter ratio | (1st:2nd) | pressure | capacity | rate |
| | [μm] | [μm] | (A/B) | [wt %] | [kN/cm] | [mAh/cm³] | [%] |
| Example 1 | 13 | 3 | 4.3 | 80:20 | 25 | 592 | 90 |
| Example 2 | 12 | 3 | 4.0 | 80:20 | 25 | 618 | 94 |
| Example 3 | 10 | 3 | 3.3 | 90:10 | 25 | 620 | 94 |
| Example 4 | 10 | 3 | 3.3 | 80:20 | 25 | 625 | 95 |
| Example 5 | 10 | 3 | 3.3 | 70:30 | 25 | 612 | 93 |
| Example 6 | 10 | 3 | 3.3 | 60:40 | 25 | 587 | 90 |
| Example 7 | 10 | 3 | 3.3 | 40:60 | 25 | 566 | 86 |
| Example 8 | 8 | 3 | 2.7 | 80:20 | 25 | 605 | 92 |
| Example 9 | 6 | 3 | 2.0 | 80:20 | 25 | 559 | 85 |
| Example 10 | 6 | 3 | 2.0 | 60:40 | 50 | 512 | 90.6 |
| Example 11 | 6 | 3 | 2.0 | 40:60 | 50 | 458 | 90.1 |
| Example 12 | 6 | 3 | 2.0 | 20:80 | 50 | 467 | 88.8 |
| Comparative | 6 | 0.1 | 60 | 80:20 | 50 | 213 | 65.1 |
| Example 1 | | | | | | | |
| Comparative | 6 | 0.1 | 60 | 60:40 | 50 | 192 | 63.2 |
| Example 2 | | | | | | | |

As shown in Table 1, when the ratio (A/B) of the average particle diameter of the first cathode active material (A) to the average particle diameter of the second cathode active material (B) was set in the range of 2.0 or more and 4.3 or less, the discharge specific capacity became high. Also, among Examples 1 to 12, the discharge specific capacity of Examples in which the average particle diameter of the first cathode active material (A) was in the range of 8 μm or more and 12 μm or less became higher than that of the other Examples. Further, among Examples 1 to 12, the discharge specific capacity of Examples in which the volume ratio of the first cathode active material and the second cathode active material was in the range of the first cathode active material:the second cathode active material=90:10 to 70:30 became higher than that of the other Examples.

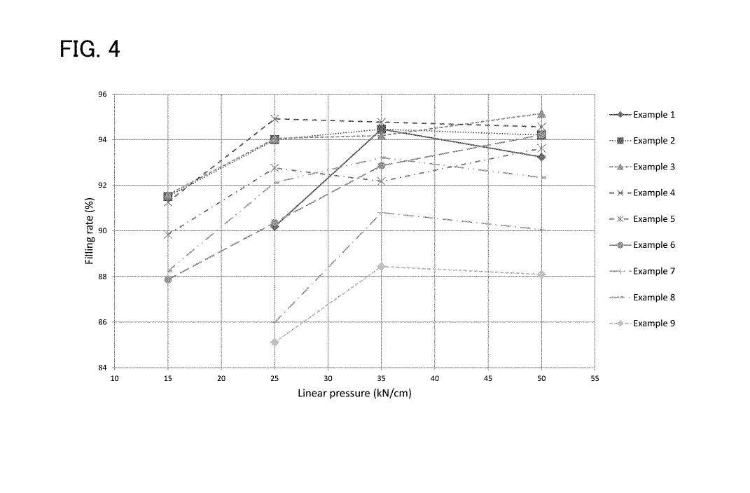

Also, cathode active material layers regarding Examples 1 to 9 were fabricated in the same manner except that the linear pressure was changed, and the filling ratio was respectively measured. The result is shown in FIG. 4. As shown in FIG. 4, it was confirmed that the filling rate equivalent to 50 kN/cm was obtained even with low pressure around pressing linear pressure of 25 kN/cm when the average particle diameter of the first cathode active material was 8 μm or more and 12 μm or less, the average particle diameter of the second cathode active material was 3 μm or less, and the proportion of the second cathode active material to the total of the first cathode active material and the second cathode active material was 10 volume % or more and 30 volume % or less.

### REFERENCE SIGNS LIST

20 . . . all solid state battery
11 . . . cathode active material layer
11a . . . cathode mixture layer
12 . . . anode active material layer
13 . . . solid electrolyte layer
14 . . . cathode current collector
15 . . . anode current collector

What is claimed is:

1. A cathode mixture to be used in an all solid state battery, the cathode mixture comprising:
a first cathode active material, a second cathode active material, and a sulfide solid electrolyte; and
a ratio of an average particle diameter of the first cathode active material to an average particle diameter of the second cathode active material is 2.0 or more and 4.3 or less.

2. The cathode mixture according to claim 1, wherein the average particle diameter of the first cathode active material is 6 μm or more and 13 μm or less.

3. The cathode mixture according to claim 1, wherein the average particle diameter of the second cathode active material is 3 μm or less.

4. The cathode mixture according to claim 1, wherein the first cathode active material and the second cathode active material are a metal oxide including at least one kind of a transitional metal selected from nickel (Ni), manganese (Mn), and cobalt (Co); and lithium (Li).

5. The cathode mixture according to claim 1, wherein the sulfide solid electrolyte contains an ion conductor including Li, P, and S; and LiBr.

6. The cathode mixture according to claim 1, wherein the first cathode active material and the second cathode active material are a compound with same constituent element.

7. A cathode active material layer to be used in an all solid state battery, the cathode active material layer comprising:
a first cathode active material, a second cathode active material, and a sulfide solid electrolyte; and
a ratio of an average particle diameter of the first cathode active material to an average particle diameter of the second cathode active material is 2.0 or more and 4.3 or less.

8. An all solid state battery comprising: a cathode active material layer, an anode active material layer, and a solid electrolyte layer formed between the cathode active material layer and the anode active material layer; wherein,
the cathode active material layer contains a first cathode active material, a second cathode active material, and a sulfide solid electrolyte; and a ratio of an average particle diameter of the first cathode active material to an average particle diameter of the second cathode active material is 2.0 or more and 4.3 or less.

9. A method for producing a cathode active material layer to be used in an all solid state battery, the method comprising:
a cathode mixture layer forming step of forming a cathode mixture layer using a cathode mixture comprising a first cathode active material, a second cathode active material, and a sulfide solid electrolyte, and a ratio of an average particle diameter of the first cathode active material to an average particle diameter of the second cathode active material is 2.0 or more and 4.3 or less; and
a roll press step of performing roll press to the cathode mixture layer.

10. The method for producing a cathode active material layer according to claim 9, wherein
the average particle diameter of the first cathode active material is 8 μm or more and 12 μm or less;
the average particle diameter of the second cathode active material is 3 μm or less;
a proportion of the second cathode active material to a total of the first cathode active material and the second cathode active material is 10 volume % or more and 30 volume % or less; and
in the roll press step, roll press is performed with a linear pressure of 20 kN/cm or more and 30 kN/cm or less.
